(19) United States
(12) Patent Application Publication
(10) Pub. No.: US 2007/0124387 A1
(43) Pub. Date: May 31, 2007

(54) Previous communication updating in instant messaging

(75) Inventor: Michael Galloway, Sunnyvale, CA (US)

Correspondence Address: MORRISON & FOERSTER LLP, 425 MARKET STREET, SAN FRANCISCO, CA, 94105-2482, US

(73) Assignee: Yahoo! Inc., Sunnyvale, CA (US)

(21) Appl. No.: 11/286,047

(22) Filed: Nov. 22, 2005

(51) Int. Cl. G06F 15/16

(52) U.S. Cl. 709/206

(57) ABSTRACT

Methods, systems, and program code for implementing instant messaging systems having a feature permitting modification/deletion/substitution of previously transmitted messages in an instant messaging session are provided. In an example, a first computer is operable to interpret a user action as a request to modify at least one previous instant message, to capture a selection to modify of the at least one previous instant message, query the user for the modification to be applied, and formulate content that indicates the modification for transmission to a server. The server is operable to receive the content, detect the modification in the content and form an update message for transmission to each client participating in the instant messaging session. Each client in the instant messaging session may be operable to receive, and use the update message for altering a display of the at least one previous instant message according to the modifications indicated.

### BACKGROUND

1. Field

The present invention relates generally to network communications, and more particularly to interactive-style electronic messaging systems, such as instant messaging systems.

2. Description of Related Art

E-mail has been an effective communication tool for a number of years. E-mail is not particularly interactive, since an e-mail is composed and sent more analogously to how post mail is composed and distributed: each piece is composed by a user and delivered, with responses handled likewise. By contrast, instant messaging systems provide a closer to real-time and more interactive electronic “conversation” capability. Businesses and consumers have adopted instant messaging. Although useful and enjoyable to use, perhaps in part due to its greater immediacy, instant messaging may yet be improved.

### SUMMARY

According to one aspect, an instant messaging system comprises logic operable to receive an instant message from a first client, to detect that the instant message includes content indicating a modification to at least one previous instant message from the first client; and to form an update message for transmission to at least one other client. The update message being for use in effecting the modification at the at least one other client. Such aspects may also be embodied in computer program code.

According to another aspect, a computer program product comprises program code to receive, from a user at a first client, a modification to at least one previous instant message sent from the first client during an instant messaging session; and generate content indicating the modification, the content useful to a second client in effecting the modification.

According to another aspect, an instant messaging method comprises receiving an instant message from a first client, detecting that the instant message includes content specifying a modification to previous communications from the first client; and forming an update message, based on the content, for transmission to a second client, the update message for use in effecting the modification at the second client.

### BRIEF DESCRIPTION OF THE DRAWINGS

For a fuller understanding of aspects and examples disclosed herein, reference is made to the accompanying drawings in the following description.

FIG. 1 illustrates clients and servers that may form instant messaging systems;

FIG. 2 illustrates a client with a display exemplifying inventive instant messenger aspects;

FIG. 3A-D illustrate an exemplary display build for a client sending an instant message formed according to inventive aspects;

FIG. 4 illustrates an exemplary flow chart for program code of the sender client;

FIG. 5 illustrates steps of an exemplary method that may be implemented in instant messaging server program code; and

FIG. 6 illustrates an exemplary flow chart for program code of a client receiving an update message from the server.

### DETAILED DESCRIPTION

The following description is presented to enable a person of ordinary skill in the art to make and use various aspects of the inventions. Descriptions of specific systems, methods, techniques, and applications are provided only as examples. Various modifications to the examples described herein will be readily apparent to those skilled in the art, and the general principles defined herein may be applied to other examples and applications without departing from the spirit and scope of the inventions. For example, aspects and examples may be employed in a variety of instant messenger configurations including systems that may not operate through a central server.

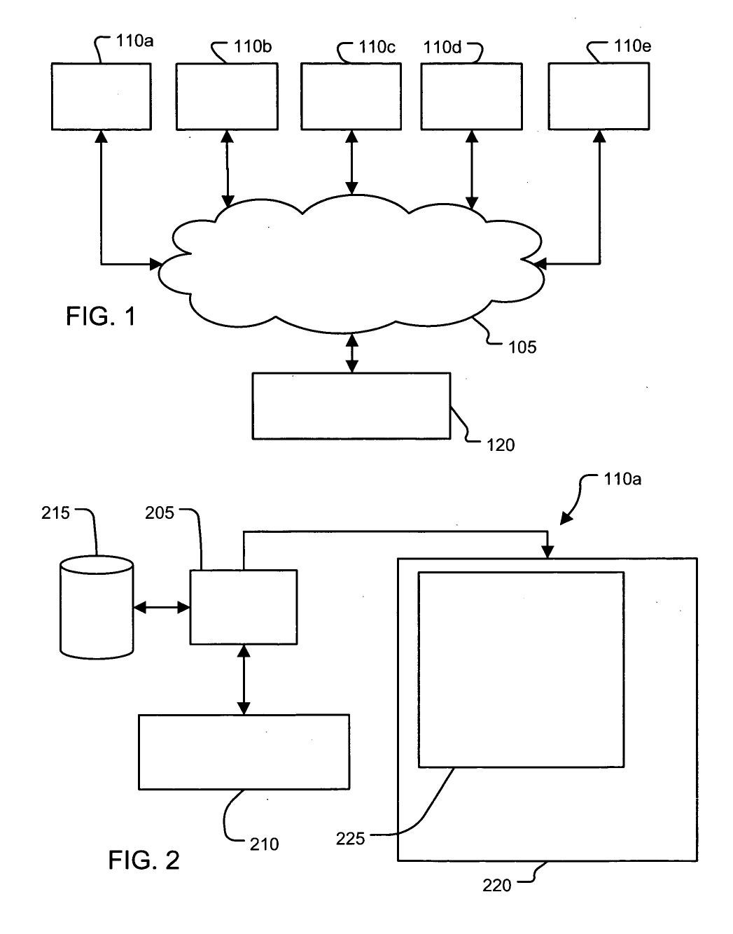

FIG. 1 illustrates a plurality of client computers 110a-e, each connected through a network 105 with a server 120. The network 105 may be composed using any of a variety of interconnected communication links, both packet and switched, public and private, wired and wireless, such as an 802.11 link in a campus LAN, the Internet, a campus LAN connected with another campus LAN over a dedicated WAN connection, or any other system for transferring data between and/or among the client computers 110a-e and the server 120.

In this example, an instant messaging system may be comprised of any combination of client computers 110a-e and the server 120. In fact, a composition of exemplary instant messaging systems may be dynamic since different groups of client computers 110a-e may be involved in various instant messaging sessions with disjoint other client computers 110a-e over time and even simultaneously. And of course, many other clients aside from client computers 110a-e may participate in instant messaging sessions with the illustrated clients and may also therefore be considered part of any such instant messaging system providing that instant messaging session.

Each of the client computers 110a-e may contain program code for communicating with each other using instant messaging. The program code may be provided by any number of sources, including any of a variety of existing instant messaging implementations, such as Yahoo!® Messenger. Aspects described herein may be applied in any such variations of instant messaging software, and other programs not specifically mentioned but which have instant messaging capabilities.

Instant messaging software may be used by a user at, for example, client computer 110a, requesting to message with friends currently logged in respectively at client computers 110b and 110c. The server 120 may alert the user that the user's friends have signed onto messaging. The user may attempt to initiate instant messaging by sending a connection request through the server 120 to each friend. Each friend may accept the connection request to initiate an instant messaging session. After accepting the connection request, the user may send a message that is received by the friends. The message may be displayed in a conversation window displayed on a monitor of each of the client computers 110a, 110b, and 110c. Likewise, the friends may respond to that message and initiate their own messages. Each message may be seen by both the user and the friends (i.e., all parties) to the session; private communications among a subset of parties to a session may also be maintained. Server 120 may keep a log of the messages exchanged during the session.

FIG. 2 schematically illustrates components of the client computer 110a; the remainder of the client computers 10b-e may have similar components. The client computer 110a may be a personal computer, a laptop, a personal digital assistant, a game console, a cell phone, or any other device capable of operating, with appropriate hardware/software control, in accordance with examples presented herein. A processing unit 205 interfaces with user input devices 210. User input devices often include a mouse and keyboard, and may also include plotters and other drawing pads, voice recognition software working with voice captured by a microphone, and other input devices such as those adapted for character (rather than alphanumeric) based languages, or assistive devices. The processing unit 205 receives input, such as text input and other control information from the user through the user input devices 210.

The processing unit 205 also interfaces with a mass storage 215, which may be a permanent storage device such as a hard drive or solid state memory, and may store operating system code, application code, and instant messenger program code. Program code may be loaded into random access memory in the processing unit 205 during usage of that application. The user may receive output through a display 220. A convenient way to represent output from a variety of applications is by segregating that output into different windows arranged in the viewable area of the display 220. One such window is instant messaging conversation window 225 (generally alluded to in regard to FIG. 1), which is used to display instant messaging communications sent and received during the instant messaging communication session.

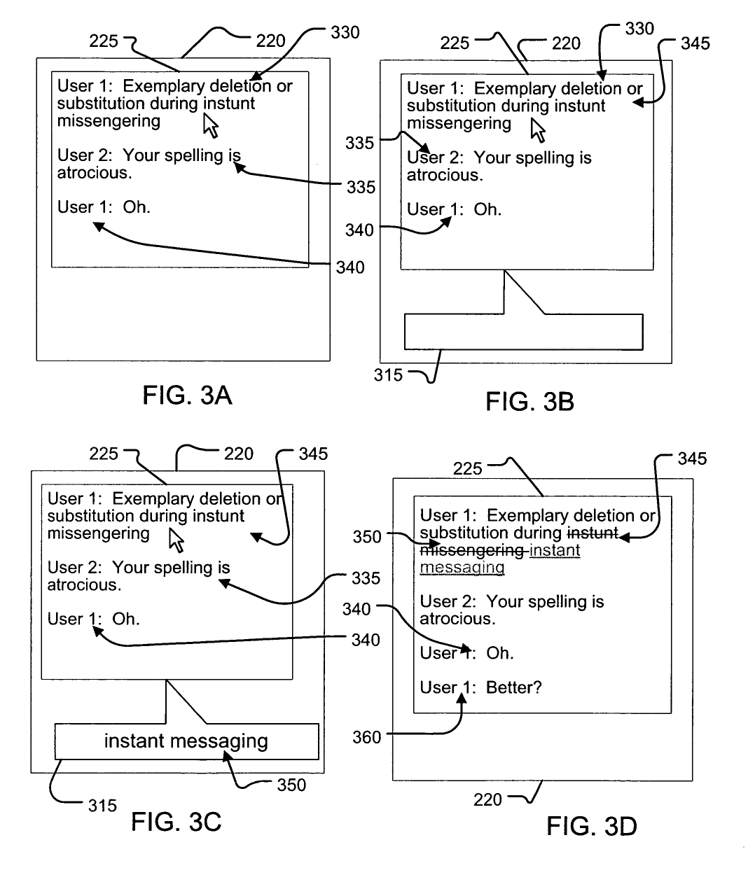

Exemplary features of instant messenger clients, servers, and associated program code may best be illustrated by reference to FIGS. 3A-D. FIG. 3A illustrates the display 220 of FIG. 2 having displayed thereon the conversation window 225. By way of example, a User 1 is currently using the client computer 110a to communicate with a User 2 located at client computer 110b. By virtue of the messages already displayed in the conversation window 225, it is apparent that User 1 and User 2 are in an established instant messaging session. User 1 has transmitted a first message 330 to User 2. User 2 has responded with a second message 335 in which User 2 criticized spelling errors made by User 1. User 1 has responded with a third message 340. In conventional instant messenger systems, User 1 cannot correct the spelling errors in the first message 330. Instead User 1 might retransmit the message, but nevertheless the first message 330 would remain unchanged.

In exemplary aspects, illustrated in FIG. 3B, User 1 may alter the message already transmitted, such that the alterations are reflected directly in the first message 330. User 1 causes the misspelled words, “instunt messengering” to be highlighted. User 1 may accomplish this highlighting by right clicking a mouse button and mousing over the words, by hitting a predetermined key and mousing over the words, or by any of a variety of other text selection techniques. The instant messenger program code being executed in the processing unit 205 (FIG. 2) of client computer 110a detects that User 1 has selected text 345 (“instunt messengering”) in the conversation window 225 for modification.

In an example, upon detecting this selection, the program code instantiates a window 315 on the display 220 outside of the conversation window 225. The window 315 provides User 1 an opportunity to enter substitute text that will replace the selected text 345. FIG. 3C illustrates exemplary entry of a substitute text 350. FIG. 3D illustrates the substitute text 350 displayed in the conversation window 225 annotated by underlining and a color change. Similarly, the selected text 345 is annotated with a strike through. As illustrated in FIG. 3D, the instant messenger program code may remove the window 315 after User 1 indicates that the substitute text 350 has been entered, for example after User 1 enters a hard return, or hits another character or some other indicia of complete entry.

With further regard to the annotations illustrated in FIG. 3D, any number of variations on the exemplary annotations are possible. For example, the selected text 345 may be displayed in a different color, may be greyed out, may be underlined with a different color underlining, or may even be entirely removed. Likewise, the substitute text 350 may be displayed in a different color, may be underlined with a different color, may be double underlined, bolded, italicized, or any number of other ways to provide emphasis to the substitute text 350. The substitute text 350 may also entirely replace the selected text 345 such that the substitute text 350 is displayed no differently than any portion of the first message 330.

As further illustrated in FIG. 3D, after the selected text 345 and the substitute text 350 (new text) are annotated according to examples described herein, User 1 may continue the conversation with another message 360. Thus, User 1 has had an opportunity to correct what may have been an inadvertent spelling error. In other situations, User 1 may have an opportunity to redact or correct a comment that may have been inadvertent or perhaps that took an unintended tone, and was not well-received by User 2.

In examples where the server 120 is maintaining a log of the session, the substitution of substitute text 350 for selected text 345 may be recorded as an annotation such that both selected text 345 and substitute text 350 are maintained in the log. The substitution may also be recorded such that only substitute text 350 is maintained. Such alternatives may be left to the discretion of the users involved in the instant messaging session, or may be determined by another person, entity, or rule based system, such as an entity maintaining the server 120.

The above description related primarily to substituting correctly spelled text for misspelled text changes to the conversation window apparent to User 1 and User 2. Other edits to and operations on previous communications (such as previous instant messages) are contemplated. One example may include deletion of text without substitution of other text, and another may include insertion of text into otherwise unchanged existing text. In either case, the text added or substituted may be referred to as new text for clarity of description.

Text for deletion may be selected similarly to how the selected text 345 was selected in the above example. A location for insertion of new text into a message, such as first message 330, may be determined by selecting (such as by right-clicking) after positioning the mouse over an insertion point in the message (e.g., a space between words). In other examples, deletion of selected text, such as the selected text 345, may also be accomplished by failing to enter a non-null substitute text in the window 315 and indicating that entry of such substitute text is complete (such as by entering a hard return).

Additionally, a variety of graphical objects or symbols, such as emoticons, JPGS of avatars, pictures and/or videos of people or objects, and the like may also be inserted or substituted for text and/or other graphical objects or symbols. In such examples, the client computer 110a may provide additional opportunities to attach such graphics and the like. Thus, the present examples are neither explicitly or implicitly limited to only text operations and communications.

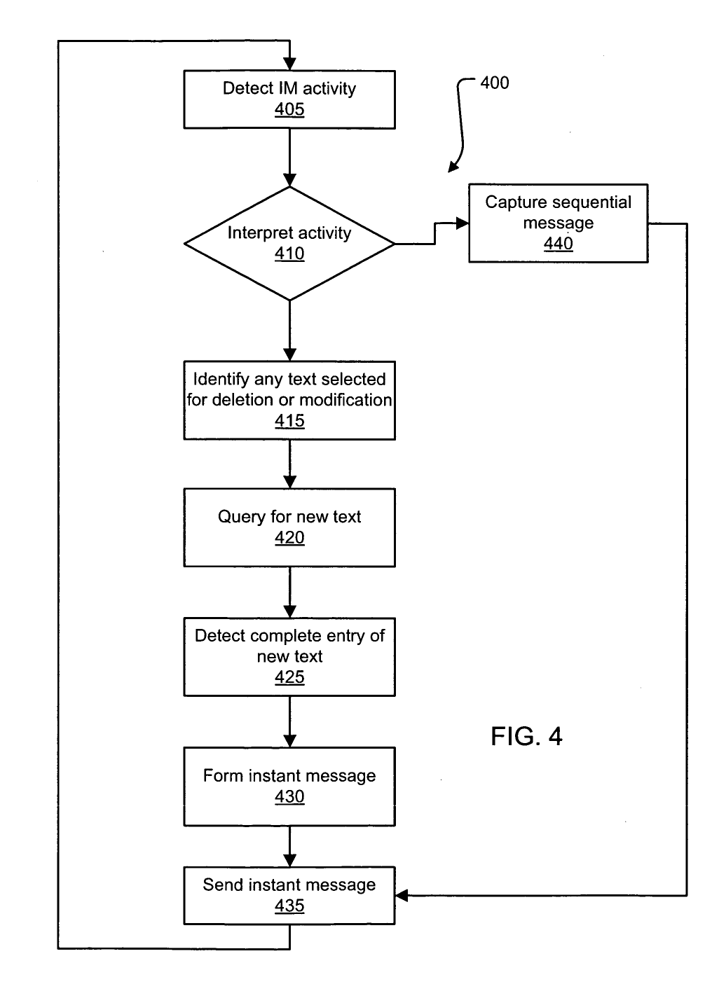

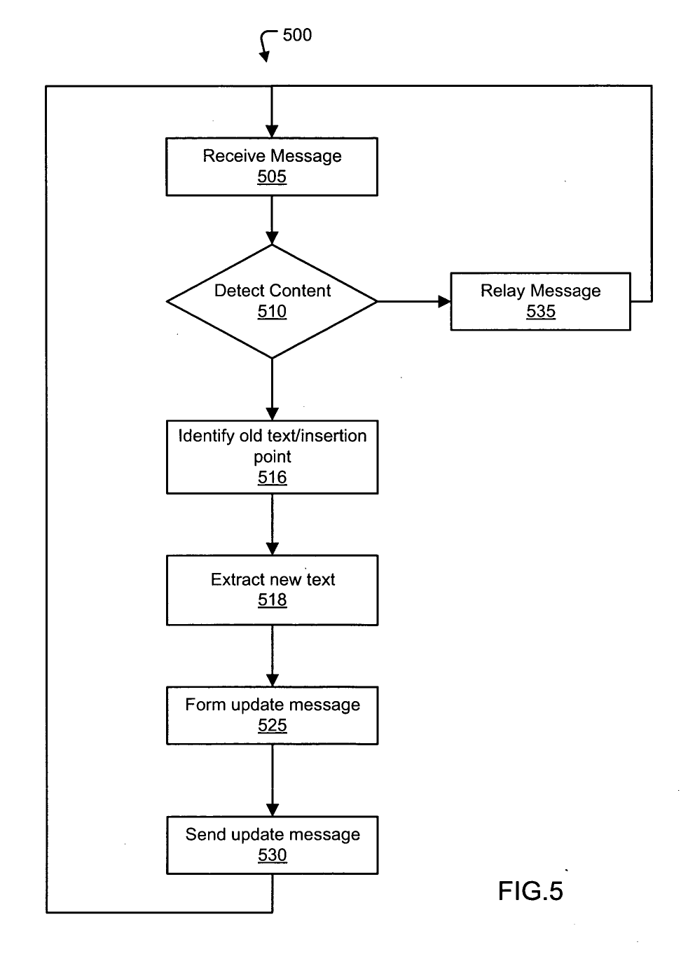

The interaction described above is exemplary and not exhaustive; many other variations are possible and some such variations may be preferred over others for particular implementations. FIGS. 4-6 illustrate examples of logical operations that may be executed by program code to provide an interaction like that described above, and other interactions according to examples and aspects presented herein. The program code may be executing respectively on the client computer 110a, the server 120, and the client computer 110b.

FIG. 4 illustrates an exemplary flow chart 400 that illustrates steps in an exemplary method that may be implemented in the instant messenger program code located at client computer 110a (i.e., the computer used by User 1 in FIGS. 3A-D above). At 405, the program code detects instant messaging activity by User 1 (e.g., may be any activity in window 225 including mouse movements or clicks, keys depressed, voice activity in voice recognition while the window 225 is active, and the like). Such activity may include entry of a new message in sequential order (e.g., message 360 in FIG. 3D) or a selection of text for update or deletion, or selection of a point to insert additional text (for example, identifying selected text 345 in FIG. 3B). At 410, the program code determines whether the activity is entry of a sequential message and if so then the program code captures the sequential message at 440 and proceeds to 435 where the sequential message is dispatched as an instant message to the server 120. If the program code determines at 410 that the activity is not entry of a sequential message (e.g, by detecting a right mouse click, or selection of previously transmitted text) then the program code provides, at 415, for identification of any text selected for deletion or substitution by new text, or a location in previous text for insertion of new text. At 420, the program code queries User 1 for entry of the new text (e.g., by establishment of the window 315 as illustrated in FIG. 3B). At 425, the program code detects indicia that entry of the new text is complete (e.g., by detecting a hard return during entry of the new text in the window 315).

At 430, the program code forms an instant message that includes content specifying any text selected for removal (hereinafter called non-current text) by either deletion or substitution out in favor of substitute text (e.g., substitute text 350 in FIG. 3C). The non-current text may be specified in any of a variety of ways, including providing a line number and column number for a beginning of the non-current text and another line number and column number specifying an end of the non-current text. The non-current text may also be included in the instant message, which would eventually be matched to text in the previous message. Entire lines of non-current text may be specified, or even entire paragraphs or pages. Any combination of such specification methods, or other specification methods may be used. Also, any number of additions, deletions and substitutions may be effected in one instant message, or each such change may be transmitted in a physically separate message. Thus, at the completion of 430, an instant message has been formed that contains content which can be interpreted by appropriate program code for effecting one or more substitutions, deletions, and additions of text as provided by User 1. At 435, the instant message is sent.

Considering the form of the instant message and the content present therein, the content may contain predefined fields for indicating begin/end locations of non-current content and for new content, the content may also contain flags or codes indicating what content is present in the instant message and its location in the message. Such variations in message structure may be prearranged between one or more of the client computers 110a and 110b and the server 120. For example, the server 120 may process the instant message from the client computer 110a into a form suitable for the client computer 110b, for example in situations where there is a difference in the instant messaging program being executed at each client.

FIG. 5 illustrates an exemplary method 500 that may be implemented by the server 120 for receiving and processing the message sent at 435 from the client computer 110a. In an example described above, the instant message sent at 435 may be a sequential message, and may not contain deletions, substitutions, or additions to text from previously sent messages. Determination whether the instant message is sequential is made at 510. If sequential, the instant message may be relayed at 535 to all appropriate participants in the instant messaging session. Relaying at 535 may include any number of other processes and steps, such as logging, that would be known by one of skill in the art. If the message is not sequential (i.e., contains deletions, additions, or substitutions) then non-current text is determined, at 516, based on the content of the instant message (e.g., by the line and column information described above).

Where there is an insertion, an insertion point may be determined at 516 based on the same information (e.g., by line and column information indicating the insertion point). At 518, new text (for substitution or addition) may be extracted from the content of the instant message. Using the identified text selected at 516 and the new text extracted at 518, an update message may be formed at 525. The update message may include annotation information for the non-current text, such as the strikethrough, color changes, and graying out features described above. The update message may also include annotation information for the new text to be substituted or added.

For clarity, the above examples described update messages as being separate from sequential messages. In practice, both updates and sequential messages may be included in the same message from the client computer 110a to the server 120. Likewise, updates and sequential messages from a plurality of users may be included in a single update message at 525.

Also, the above examples provided for inclusion of annotation information by the server 120 in the update message formed at 525. In other examples, the server 120 may not include particular font, color, and other such changes in the update message but instead may form the update message to include information identifying the non-current text and include text for substitution or addition. In such examples, instant messenger program code operating at each client computer (such as client computer 110b) involved in an instant messaging session, would include logic for appropriately annotating such non-current and additional or substitute text. Such annotations may also be user selectable based on preferences of a user expressed in various configuration settings provided by instant messenger program code. Such configuration settings may include determining a color of underlining, strike-through lines, fonts, colors of text deleted, substituted, and/or added, and the like.

The above description with reference to FIGS. 2-5 primarily related exemplary interactions between a user acting to substitute, add, or delete previously entered content at client computer 110a and processing by the server 120 of an instant message capturing those actions. With regard to updating and annotating text in conversation window 225 of client computer 110a (e.g., annotations by User 1 in FIGS. 3A-e), those annotations may be completed locally (without interaction with the server 120) or they may be completed after receiving the update message sent at 530 (FIG. 5), like the client computer 110b. In such an architecture, each client computer may submit information to the server 120, but updates a respective conversation window with update messages from the server 120, and not based both on locally inputted information and update messages from the server 120.

The above example involved formation of an update message by the server 120 based on non-sequential content from client computer 110a. In other exemplary instant messaging systems and architectures, centralized servers may be relied upon less heavily for getting updates of previous communications to client computers. For example, the server 120 may merely process an instant message to obtain enough information to maintain an appropriate log of the conversation and then relay the message to other participants in the instant messaging session. In even more peer to peer based architectures, clients may send instant messages to each other without involvement of a centralized server, and those instant messages may contain updates to previous communications. In such examples, one client may relay an update to previous communications to another client known to be participating in the instant messaging session. In other examples, a client computer may function as both the server 120 and participate as a client in the instant messaging session.

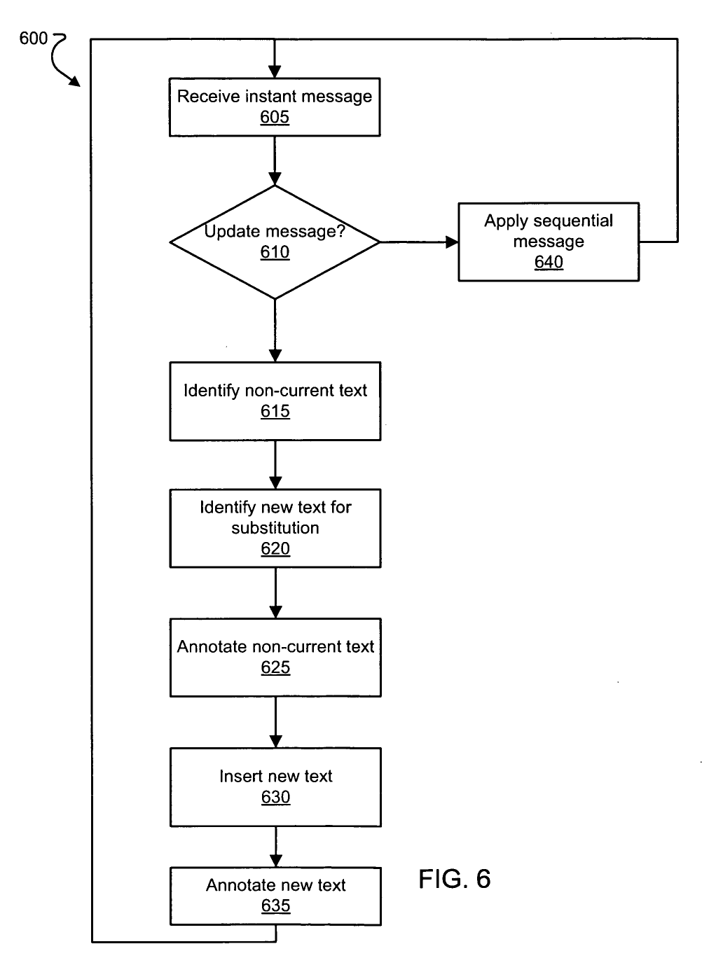

FIG. 6 illustrates exemplary actions taken by a client computer receiving an update message from the server 120 (e.g., client computer 110b involved in the interaction of FIGS. 3A-D) according to various aspects described above.

At 605, the client computer 110b receives an instant message from the server 120. The instant message may be an update message or a sequential message according to one example. If the instant message is sequential, the contents of the instant message are displayed at the next available location in a conversation window displayed on a monitor of the client computer 110b. If the instant message is an update message, then non-current text is identified at 615 using content of the instant message, such as for example the line and column information described above. A place for addition of new text may also be identified at 615. At 620, new text for substitution or addition is identified in content of the instant message. At 625, the non-current text is annotated in the conversation window. At 630, annotations (e.g., underlining, strikethroughs, color changes, and the like) may be derived from the content of the instant message or formed based on preferences obtained from the user at client computer 110b. Those annotations are applied such that the new text is displayed appropriately annotated in the conversation window at 635.

Additional functionality of program code executing on the client computer 110b is contemplated. For example, in a long instant messaging session, not all the previous communications from User 1 and displayed in the conversation window at client computer 110b (for User 2) may be visible. User 1 may choose to edit a previous communication that is not currently visible. This situation may be handled in a number of ways. One way is that the program code may cause the conservation window at client computer 110b to scroll back so that the annotated previous communication can be displayed. Other logic may prevent User 1 from editing a previous communication that is not recent enough to permit editing. For example, a number of messages, or passage of time, or some other appropriate characteristic may be used to judge whether a previous communication is not recent enough.

The above examples presented with regard to FIGS. 2-5 provide an example where User 1 at client computer 110a edits a previous communication, and client computer 110b processes those edits for output (e.g., display) at client computer 110b for User 2. One of ordinary skill in the art would understand that in many typical instant messaging systems, any participant may edit previous communications made by that participant using the above described methods, software, and systems (i.e., the instant messaging functionality may be symmetric). In other variations, a moderator may control editing and updating of previous communications. And in still other variations, one user may offer a proposed update to previous communications of another user. In such variations, the user who made the communications or a moderator may be provided ultimate authority to approve or disapprove of such proposed updates, or such proposed updates may be annotated differently as proposed but not approved updates. One of ordinary skill in the art would understand how to implement such further variations and examples based on the disclosure provided herein.

This description is exemplary and it will be apparent to those of ordinary skill in the art that numerous modifications and variations are possible. For example, various exemplary methods and systems described herein may be used alone or in combination with various operating systems, computer systems, and program code implementing instant messaging systems. Additionally, particular examples have been discussed and how these examples are thought to address certain disadvantages in related art. This discussion is not meant, however, to restrict the various examples to methods and/or systems that actually address or solve the disadvantages.

We claim:

1. An instant messaging system comprising logic operable to:
receive an instant message from a first client;
detect that the instant message includes content indicating a modification to at least one previous instant message from the first client; and
form an update message for transmission to at least one other client, the update message for use in effecting the modification at the at least one other client.

2. The instant messaging system of claim 1, further comprising logic at the first client operable to
receive the modification to the at least one previous instant message; and
generate the content indicating the modification for inclusion in the instant message.

3. The instant messaging system of claim 2, wherein to receive the modification, the first client includes logic operable to
capture a selection by the user of a portion to be modified of the at least one previous instant message; and
query the user for the modification.

4. The instant messaging system of claim 3, further comprising logic at the at least one other client operable to
receive the update message from the server; and
alter a display of the selection, in accordance with content of the update message, to effect the modification.

5. The instant messaging system of claim 4, wherein to alter includes annotating the selection in a display window at the at least one other client, the annotation for indicating that the selection is no longer current.

6. The instant messaging system of claim 5, wherein the annotation of the selection is one or more of a strike-through line and a color change.

7. The instant messaging system of claim 3, wherein the modification is one of deleting the selection and substituting an alternate selection.

8. The instant messaging system of claim 7, wherein the alternate selection is annotated with one or more of an underlining, and a color change.

9. The instant messaging system of claim 3, wherein the at least one previous instant message includes text, the text displayed in a window at the first client, and the first client further comprises logic operable to establish a distinct window in which the user may enter substitute text in response to the query.

10. The instant messaging system of claim 9, wherein the logic operable to establish the distinct window is further operable to remove the window in response to indicia of substitute text entry completion.

11. The instant messaging system of claim 1, wherein the at least one previous instant message is displayed at the first client, the update message is also for transmission to the first client, and the first client is operable to receive the update message and alter the display of the at least one previous instant message in accordance with the update message.

12. The instant messaging system of claim 1, wherein the at least one previous instant message includes lines of text, and the content of the instant message from the first client includes line and character information for both a start and an end of a selected for modification portion of the lines of text, an identification for determining an instant messaging session to which the instant message pertains, and alternate text to be substituted for the selected for modification portion.

13. A computer program product comprising program code to:
receive an instant message from a first client;
detect that the instant message includes content indicating a modification to at least one previous instant message from the first client; and
form an update message, based on the content, for transmission to at least one other client, the update message for use in effecting the modification at the at least one other client.

14. The computer program product of claim 13, further comprising program code to
receive, from a user at the first client, the modification to the at least one previous instant message; and
generate the content indicating the modification.

15. The computer program product of claim 14, wherein the program code is operable to receive the modification by determining a portion of the at least one previous instant message selected by the user for modification; and by providing the user an opportunity to input an update to be applied during the modification.

16. The computer program product of claim 13, further comprising program code to:
receive the update message; and
effect the modification by altering a display, in accordance with the update message, of the at least one previous instant message at the at least one other client.

17. A computer program product comprising program code to:
receive, from a user at a first client, a modification to at least one previous instant message sent from the first client during an instant messaging session; and
generate content indicating the modification, the content useful to a second client in effecting the modification.

18. The computer program product of claim 17, further comprising program code to:
capture a selection by the user of a portion to be modified of the at least one previous instant message; and
query the user for the modification.

19. The computer program product of claim 18, further comprising program code for transmission of the outbound instant message to a server for formation of an update message for sending to the second client.

20. The computer program product of claim 19, wherein the update message is also for sending to the first client and the at least one previous instant message is displayed at the first client, and further comprising program code to receive the update message at the first client and alter the display of the portion of the at least one previous instant message, in accordance with the update message.

21. The computer program product of claim 17, further comprising program code to:
receive an inbound instant message at the first client having content from the second client, the content for updating the at least one previous instant message from the second client to the first client; and
effect the updates indicated by the content of the inbound instant message in a window on a display of the first client.

22. An instant messaging method, comprising:
receiving an instant message from a first client;
detecting that the instant message includes content specifying a modification to previous communications from the first client; and
forming an update message, based on the content, for transmission to a second client, the update message for use in effecting the modification at the second client.

23. The instant messaging method of claim 22, further comprising:
receiving, from a user at the first client, the modification to the previous communications; and
generating the content indicating the modification.

24. The instant messaging method of claim 23, wherein receiving includes
capturing a selection by the user of a portion of the previous communications; and
querying the user for the modification to be applied.

25. The instant messaging method of claim 24, wherein the second client receives the update message; and alters, in accordance with the update message, the portion of the previous communications for display at the second client.

26. The instant messaging method of claim 22, further comprising:
receiving an inbound update message at the first client having content from the second client, the content indicating an update to the previous communications from the second client to the first client; and
effecting the updates indicated by the content of the inbound update message in a window on a display of the first client.

27. The instant messaging system of claim 22, wherein the previous communications are displayed at the first client, the update message is also for transmission to the first client, and further comprising receiving the update message at the first client and altering display of the previous communications in accordance with the update message.
